(19) United States
(12) Patent Application Publication
(10) Pub. No.: US 2024/0053956 A1
(43) Pub. Date: Feb. 15, 2024

(54) VOICE INTEGRATED USER INTERFACE FOR A DOMESTIC APPLIANCE

(71) Applicant: Haier US Appliance Solutions, Inc., Wilmington, DE (US)

(72) Inventors: Donald James Leisl, III, Louisville, KY (US); Richard Gary Woodham, JR., Taylorsville, KY (US); Mark Anthony Didat, Floyds Knobs, IN (US); Bradley Duane Ford, JR., Vine Grove, KY (US)

(21) Appl. No.: 17/885,659

(22) Filed: Aug. 11, 2022

(51) Int. Cl. G06F 3/16; D06F 34/28; D06F 34/08; H04R 1/02; H04R 1/08

(52) U.S. Cl. CPC G06F 3/167; D06F 34/28; D06F 34/08; H04R 1/025; H04R 1/08; D06F 2105/60

(57) ABSTRACT

A domestic appliance including a cabinet, a user interface including an interface printed circuit board (PCB), a voice module PCB operably connected with the interface PCB, the voice module PCB including one or more voice assistant modules, a microphone PCB provided separate from the voice module PCB, the microphone PCB having a plurality of microphone receivers attached thereto, the microphone PCB being operably connected with the voice module PCB, and a speaker operably connected with the voice module PCB.

### FIELD OF THE INVENTION

The present subject matter relates generally to domestic appliances, and more particularly to voice activated user interfaces for domestic appliances.

### BACKGROUND OF THE INVENTION

Household appliances, including laundry appliances, are becoming increasingly connected with the internet and each other. Many household appliances are incorporating so called smart systems or digital assistants into their user interfaces, which allow for easier and more interactive operation and communication between the appliance and a user or users. For at least one example, voice recognition and operation are being integrated into household appliances, allowing users to operate the appliance, request information, and/or manage day-to-day activities via voice command.

For their part, voice command assistants typically include a microphone assembly, an internet connected device capable of receiving input signals and analyzing various information, and a speaker to output audio responses and cues. Conventionally, each of these elements is provided as a single package, such as a smart speaker. However, many domestic appliances lack the appropriate amount of space to accommodate full voice command assistants.

Accordingly, an appliance that obviates one or more of the above-mentioned drawbacks would be beneficial. Particularly, a user interface of a domestic appliance with a voice assistant assembly (e.g., within a compact or efficient space that does not significantly increase the volume of the domestic appliance) would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a domestic appliance is provided. The domestic appliance may include a cabinet, a user interface comprising an interface printed circuit board (PCB), a voice module PCB operably connected with the interface PCB, the voice module PCB including one or more voice assistant modules, a microphone PCB provided separate from the voice module PCB, the microphone PCB having a plurality of microphone receivers attached thereto, the microphone PCB being operably connected with the voice module PCB, and a speaker operably connected with the voice module PCB.

In another exemplary aspect of the present disclosure, a user interface assembly for an appliance is provided. The user interface assembly may include an interface printed circuit board (PCB), a voice module PCB operably connected with the interface PCB, the voice module PCB including one or more voice assistant modules, a microphone PCB provided separate from the voice module PCB, the microphone PCB having a plurality of microphone receivers attached thereto, the microphone PCB being operably connected with the voice module PCB, and a speaker operably connected with the voice module PCB.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a laundry appliance according to an exemplary embodiment of the present subject matter with a door of the laundry appliance shown in a closed position.

FIG. 2 provides a perspective view of the laundry appliance of FIG. 1 with the door of the exemplary laundry appliance shown in an open position.

FIG. 3 provides an exploded view of a user interface of the laundry appliance of FIG. 1.

FIG. 4 provides a close-up front view of the exemplary user interface of FIG. 3.

FIG. 5 provides a side cut-away view of the exemplary user interface of FIG. 3.

FIG. 6 provides a rear perspective view of the exemplary user interface of FIG. 3.

FIG. 7 provides a rear perspective view of an interior of the exemplary user interface of FIG. 3.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

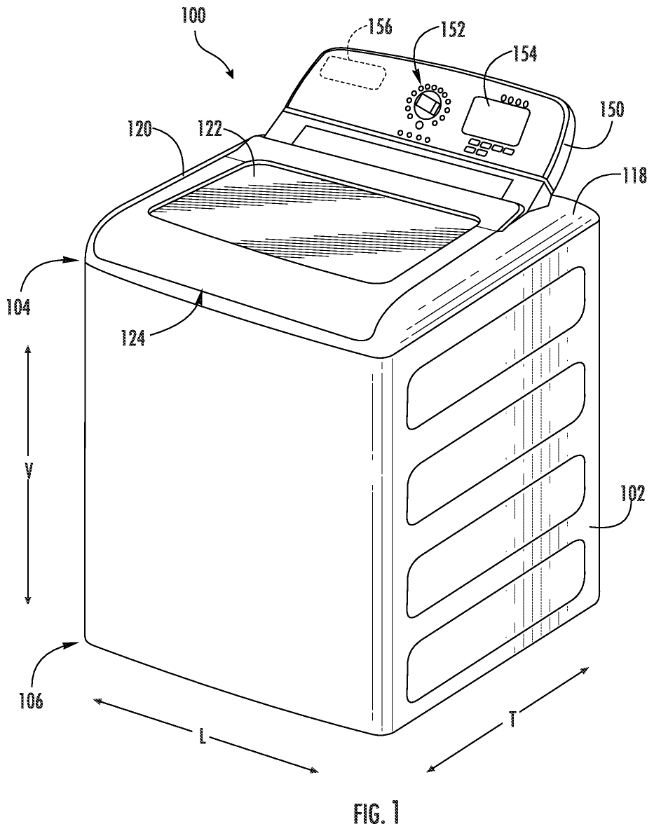

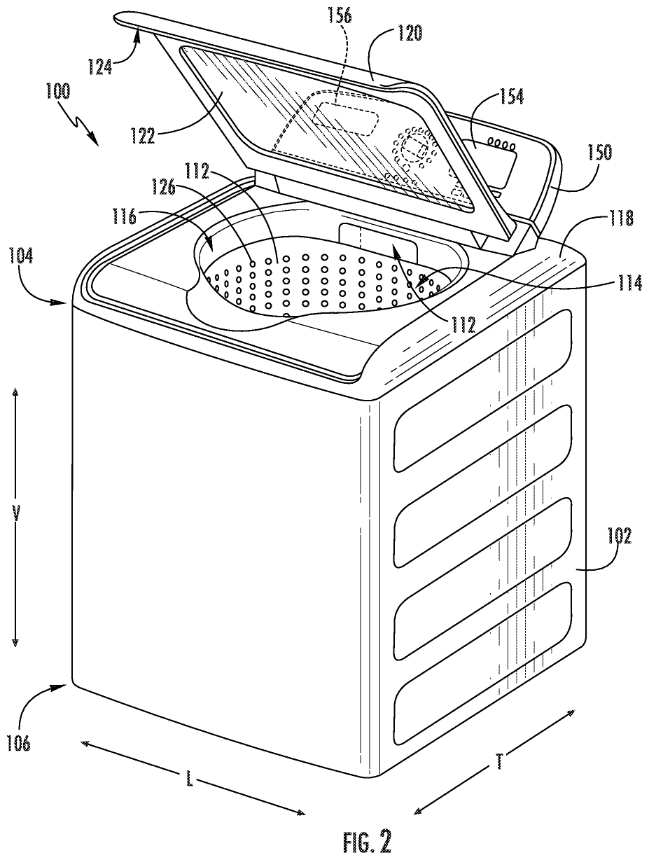

FIGS. 1 and 2 illustrate an exemplary embodiment of a vertical axis washing machine appliance or laundry treatment appliance 100. Specifically, FIGS. 1 and 2 illustrate perspective views of washing machine appliance 100 in a closed and an open position, respectively. Washing machine appliance 100 generally defines a vertical direction V, a lateral direction L, and a transverse direction T, each of which is mutually perpendicular, such that an orthogonal coordinate system is generally defined.

While described in the context of a specific embodiment of a vertical axis washing machine, it should be appreciated that vertical axis washing machine appliance 100 is provided by way of example only. It will be understood that aspects of the present subject matter may be used in another suitable washing machine appliance, such as a horizontal axis washing machine appliance. Indeed, modifications and variations may be made to washing machine appliance 100, including different configurations, different appearances, and/or different features while remaining within the scope of the present subject matter. Additionally or alternatively, it will be understood that aspects of the present disclosure may be used in other domestic appliances apart from washing machine appliances or laundry appliances, such as oven ranges, microwaves, refrigerators, dishwashers, or the like. Accordingly, hereinafter, washing machine appliance 100 may be referred to simply as appliance 100 or domestic appliance 100.

Appliance 100 may have a cabinet 102 that extends between a top portion 104 and a bottom portion 106 along the vertical direction V. A tub (e.g., wash tub) 108 may be positioned within cabinet 102 and is generally configured for retaining wash fluids during an operating cycle. Appliance 100 may further include a primary dispenser 110 (FIG. 2) for dispensing wash fluid into tub 108. The term “wash fluid” refers to a liquid used for washing and/or rinsing articles during an operating cycle and may include any combination of water, detergent, fabric softener, bleach, and other wash additives or treatments.

In addition, appliance 100 may include a wash basket 112 that is positioned within tub 108 and generally defines a wash chamber 114 including an opening 116 for receipt of articles for washing. More specifically, wash basket 112 may be rotatably mounted within tub 108 such that it is rotatable about an axis of rotation. According to the illustrated embodiment, the axis of rotation is substantially parallel to the vertical direction V. In this regard, appliance 100 may be generally referred to as a “vertical axis” or “top load” washing machine appliance 100. However, as noted above, it should be appreciated that aspects of the present subject matter may be used within the context of a horizontal axis or front load washing machine appliance, as well as other domestic appliances.

As illustrated, cabinet 102 of appliance 100 may have a top panel 118. Top panel 118 may define an opening (FIG. 2) that coincides with opening 116 of wash basket 112 to permit a user access to wash basket 112. Appliance 100 may further include a door 120 which is rotatably mounted to top panel 118 to permit selective access to opening 116. In particular, door 120 selectively rotates between the closed position (as shown in FIG. 1) and the open position (as shown in FIG. 2). In the closed position, door 120 inhibits access to wash basket 112. Conversely, in the open position, a user can access wash basket 112. A window 122 in door 120 permits viewing of wash basket 112 when door 120 is in the closed position, e.g., during operation of appliance 100. Door 120 may also include a handle 124 that, e.g., a user may pull and/or lift when opening and closing door 120. Further, although door 120 is illustrated as mounted to top panel 118, door 120 may alternatively be mounted to cabinet 102 or any other suitable support.

As best shown in FIG. 2, wash basket 112 may further define a plurality of perforations 126 to facilitate fluid communication between an interior of wash basket 112 and tub 108. In this regard, wash basket 112 is spaced apart from tub 108 to define a space for wash fluid to escape wash chamber 114. During a spin cycle, wash fluid within articles of clothing and within wash chamber 114 is urged through perforations 126 wherein it may collect in a sump defined by tub 108. Appliance 100 may further include a drain pump assembly that is located beneath tub 108 and wash basket 112 for gravity assisted flow when draining tub 108, e.g., after a wash or rinse cycle.

An impeller or agitator, such as a vane agitator, impeller, auger, oscillatory basket mechanism, or some combination thereof may be disposed in wash basket 112 to impart an oscillatory motion to articles and liquid in wash basket 112. More specifically, the agitator may extend into wash basket and assist agitation of articles disposed within wash basket 112 during operation of appliance 100, e.g., to facilitate improved cleaning. In different embodiments, the agitator includes a single action element (i.e., oscillatory only), a double action element (oscillatory movement at one end, single direction rotation at the other end) or a triple action element (oscillatory movement plus single direction rotation at one end, single direction rotation at the other end). Additionally or alternatively, the agitator may be omitted entirely according to certain embodiments.

Operation of appliance 100 may be controlled by a controller or processing device 156 that is communicatively coupled with a control panel 150 (described in further detail below) for user manipulation to select washing machine cycles and features, for example. Controller 156 may operate the various components of appliance 100 to execute selected machine cycles and features. Controller 156 may include a memory and microprocessor, such as a general or special purpose microprocessor operable to execute programming instructions or micro-control code associated with methods described herein. Alternatively, controller 156 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Control panel 150 and other components of appliance 100 may be in communication with controller 156 via one or more signal lines or shared communication busses.

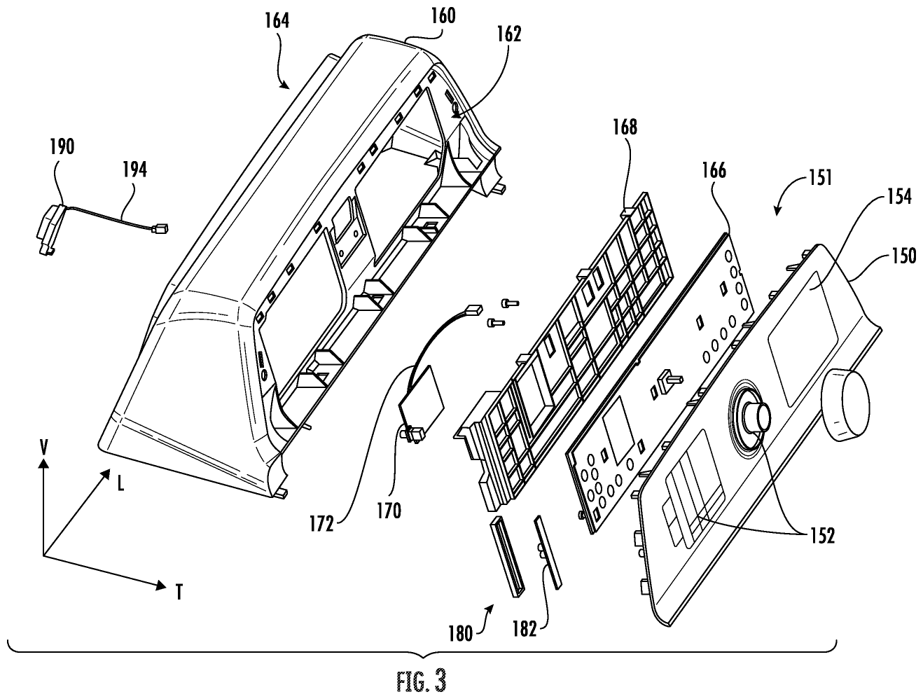

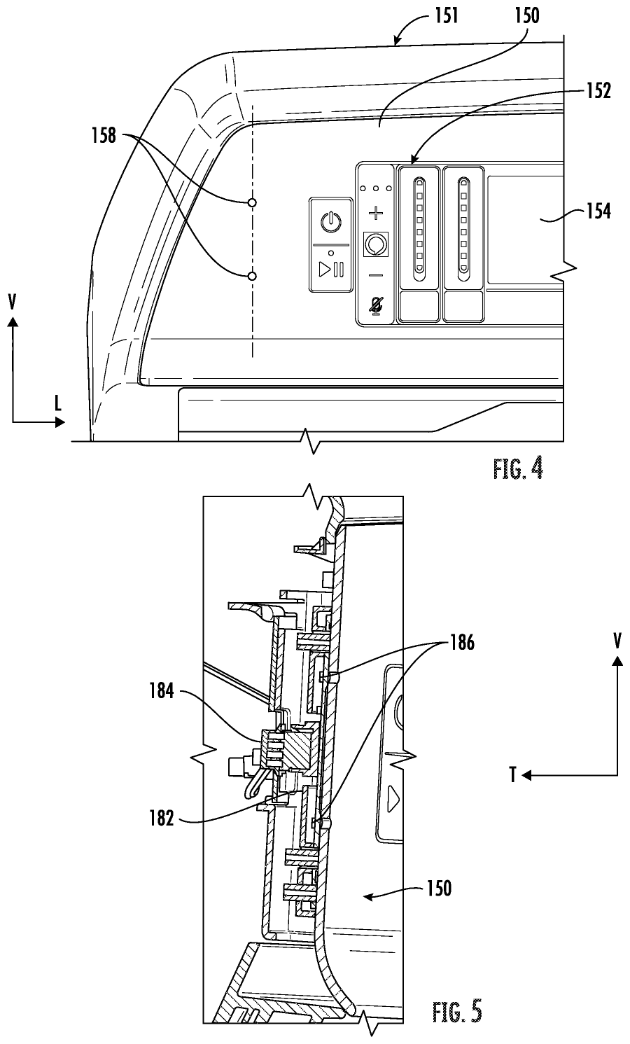

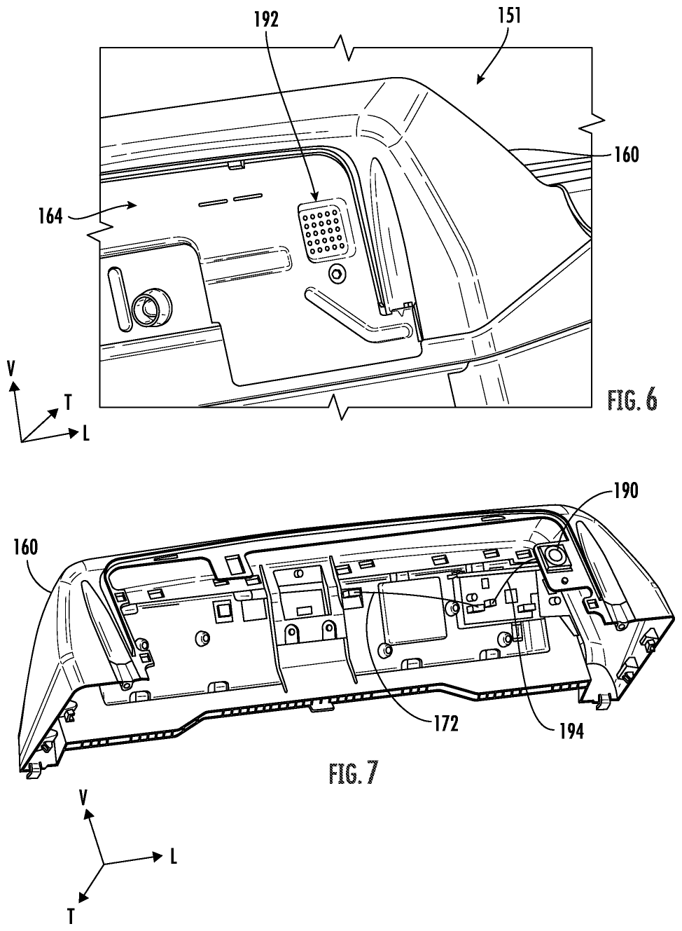

Referring to FIGS. 1 through 7, a user interface assembly including control panel 150 will be described in detail. For instance, control panel 150 may include at least one input selector 152 (FIG. 1). Control panel 150 and input selector 152 may collectively form a user interface 151 for operator selection of machine cycles and features. A display 154 of control panel 150 indicates selected features, operation mode, a countdown timer, and/or other items of interest to appliance users regarding operation.

An interface housing 160 may be attached to cabinet 102. In detail, interface housing 160 may extend from cabinet 102 (e.g., along the vertical direction V) at a rear portion of cabinet 102. Control panel 150 may be attached to interface housing 160. For instance, interface housing 160 may include a front face 162 (e.g., facing toward a front of washing machine appliance 100) and a rear face 164 (e.g., opposite front face 162 and facing toward a rear of washing machine appliance 100). Control panel 150 may be attached to front face 162 of interface housing 160. Front face 162 may form one or more struts to which control panel 150 is coupled (e.g., via one or more fasteners, adhesives, magnets, snaps, clips, or the like). According to some embodiments, control panel 150 forms front face 162 of interface housing 160. In other words, control panel 150 may be formed integrally with interface housing 160.

User interface 151 may include an interface printed circuit board (PCB) 166. Interface PCB 166 may be accommodated within interface housing 160. For instance, interface housing 160 may form a receiving zone or receiving space (e.g., between front face 162 and rear face 164) in which one or more components may be positioned. Interface PCB 166 may be operably connected with control panel 150 (e.g., and input selectors 152). Additionally or alternatively, interface PCB 166 may be operably connected with controller 156. According to some embodiments, interface PCB 166 operates as control panel 150. Thus, interface PCB 166 may include a plurality of electrical elements such as light emitting diodes (LEDs), touch buttons, electrical receptors, and the like. Interface PCB 166 may be connected to a fascia (e.g., control panel 150) as well as interface housing 160. For example, interface PCB 166 is attached to each of control panel 150 and interface housing 160 via a mechanical connection (e.g., fasteners, heat stakes, snaps, adhesives, magnets, clips, or the like).

A voice module 170 may be accommodated within interface housing 160. In detail, voice module 170 may be a voice module PCB operably connected with interface PCB 166. Voice module PCB 170 and interface PCB 166 may be connected, for example, via a board-to-board harness 172. Accordingly, signals (e.g., electrical signals) may be exchanged between interface PCB 166 and voice module PCB 170. In detail, inputs (e.g., commands, voice inputs, queries, etc., explained in more detail below) to voice module 170 may be transferred to interface PCB 166. Accordingly, analysis performed by voice module 170 may be presented to control panel 150 via interface PCB upon receiving information signals from voice module 170.

Voice module 170 may include artificial intelligence (AI) software components (e.g., voice assistant modules) providing voice activated assistance to users. For instance, voice module 170 may include network connected algorithms capable of communicating with multiple other network connected appliances within a household. Accordingly, voice module 170 may include software programs implemented by a controller (e.g., controller 156). Additionally or alternatively, voice module 170 may be connected through the Internet to retrieve and present information and/or multimedia (e.g., music, video, etc.). Voice module 170 may utilize artificial intelligence, neural networks, machine learning, or deep learning algorithms that are speaker dependent. Accordingly, voice module 170 may be trained to recognize a keyword and initiate activation and interaction upon recognizing the keyword.

Appliance 100 may include an interface board bracket 168. Interface board bracket 168 may be accommodated within interface housing 160. For instance, interface board bracket 168 may be provided behind interface PCB 166 (e.g., within interface housing 160). Interface board bracket 168 may be selectively coupled with one or more of interface housing 160 (e.g., front face 162 or rear face 164), control panel 150, voice module 170, or additional modules or PCBs (described below). Interface board bracket 168 may include or be provided as a plastic piece injected molded to accept connection pieces associated with the interface housing 160, control panel 150, voice module 170, etc. For instance, a plurality of complementary voids (e.g., snap hooks, threaded apertures, flexible tabs, etc.) may be formed in interface board bracket 168. Each of interface housing 160, control panel 150, voice module 170, etc. may be fixed to one or more of the complementary voids. Accordingly, interface board bracket 168 may provide a strategic arrangement and organization of each piece of equipment accommodated within interface housing 160.

Appliance 100 may include a microphone assembly 180 accommodated within interface housing 160. In detail, microphone assembly 180 may include a microphone PCB 182. Microphone PCB 182 may be provided separately from voice module PCB 170. For instance, microphone PCB 182 may be a separate PCB from voice module 170. Accordingly, microphone PCB 182 may be positioned at a plurality of locations within interface housing 160 (e.g., spaced apart from voice module 170). Additionally or alternatively, microphone PCB 182 may be positioned outside of interface housing 160. Microphone PCB 182 may be electrically connected with voice module PCB 170 via a board-to-board harness 184. Accordingly, signals (e.g., electronic signals) may be exchanged between microphone PCB 182 and voice module 170.

Microphone PCB 182 may be attached to interface PCB 166. Additionally or alternatively, microphone PCB 182 may be attached to control panel 150. For instance, microphone PCB 182 may be attached to a rear face of control panel 150 (e.g., within interface housing 160). Microphone PCB 182 may be attached via any suitable method (e.g., fasteners, snaps, adhesives, clips, magnets, heat stakes, etc.). According to some embodiments, microphone PCB 182 is attached to front face 162 of interface housing 160 (e.g., proximate control panel 150). It should be noted that microphone PCB 182 may be positioned at any suitable location on or in appliance 100 (e.g., within interface housing 160).

Microphone PCB 182 may include a plurality of microphone receivers 186 attached thereto. For at least one example, two microphone receivers 186 are provided. For the sake of brevity, a single microphone receiver 186 will be described herein with the understanding that the description is applicable to each microphone receiver 186. Microphone receiver 186 may be used for monitoring the sound waves, noises, or other vibrations generated by a user near appliance 100. For example, microphone receiver 186 may be one or more microphones, acoustic detection devices, vibration sensors, or any other suitable acoustic transducers that are positioned at one or more locations in or around appliance 100. For example, according to exemplary embodiments, microphone receiver 186 may be mounted within interface housing 166 for detecting any sounds within audible range of appliance 100. Additionally or alternatively, microphone receiver 186 may be positioned elsewhere within appliance 100. In this regard, any suitable microphone receiver 186 that is acoustically or electrically coupled with appliance 100 (e.g., voice module 170) may be used to monitor sounds. Microphone receiver 186 may be communicatively coupled to (i.e., in operative communication with) controller 156.

Moreover, user interface 151 (e.g., control panel 150) may include a plurality of microphone holes 158 formed therein. For instance, the number of microphone holes 158 may correspond to the number of microphone receivers 186 provided on microphone PCB 182. For instance, if two microphone receivers 186 are provided on microphone PCB 182, two microphone holes 158 are formed in user interface 151. Accordingly, microphone receivers 186 may be positioned proximate microphone holes 158 (e.g., facing outward from interface housing 166). According to at least some embodiments, the plurality of microphone holes 158 are positioned at a lateral side of user interface 151 (e.g., a lateral side of appliance 100 or interface housing 166). Advantageously, the plurality of microphone holes 158 may not interfere with input selectors 152, display 154, or any other features on control panel 150, providing a seamless and efficient organization and presentation of control panel 150.

Microphone receivers 186 may be spaced apart from each other on microphone PCB 182. In detail, microphone receivers 186 may be spaced apart from each other along the vertical direction V. As shown in FIG. 4, microphone receivers 186 (and the corresponding microphone holes 158) may be orientated along the vertical direction V within interface housing 166 (and on control panel 150). Accordingly, microphone receivers 186 may form a vertical array. Accordingly, microphone PCB 182 (and microphone receivers 186) may be easily and conveniently positioned within interface housing 166 and presented on control panel 150. It should be noted that any suitable number of microphone receivers 186 may be provided on microphone PCB 182, and the disclosure is not limited to the examples given herein. Additionally or alternatively, multiple microphone PCBs 182 may be provided at different locations within interface housing 160.

Appliance 100 may include a speaker 190. Speaker 190 may be provided within interface housing 160. For instance, speaker 190 may be provided at or near a rear (e.g., rear face 164) of interface housing 160. According to some embodiments, speaker 190 is attached to an interior surface of rear face 164 of interface housing 160. Speaker 190 may be attached to rear face 164 via any suitable manner (e.g., fasteners, snaps, adhesives, clips, magnets, heat stakes, etc.). Accordingly, speaker 190 may project acoustic waves (e.g., sound waves) out from a rear of interface housing 160.

Speaker 190 may be any suitable speaker or transducer capable of emitting audio signals. As described above, speaker 190 may be associated with smart software to provide information and assistance to users via audio prompts (e.g., via voice module 170). Speaker 190 may also output various alerts and tones. For instance, speaker 190 may play tones to signal a cycle end time, a fault of the appliance, a timer conclusion or warning, or the like. Speaker 190 may be fully integrated with control panel 150.

Rear face 164 of interface housing 160 may include a speaker outlet 192. For instance, speaker outlet 192 may be formed as an opening (e.g., aperture) in rear face 164. According to some embodiments, speaker outlet 192 is formed as a plurality of apertures allowing fluid communication between the interior of interface housing 160 and an ambient atmosphere. Speaker 190 may be positioned proximate speaker outlet 192. For example, speaker 190 is located adjacent to speaker outlet 192. Moreover, an outlet direction of speaker 190 may be directed at speaker outlet 192. Advantageously, the sound output from speaker 190 may be directed outward from interface housing.

Speaker 190 may be operably coupled with voice module 170. For instance, speaker 190 may be electrically connected to voice module 170 via a board-to-board harness 194. Accordingly, signals (e.g., electronic signals) may be exchanged between speaker 190 and voice module 170. Additionally or alternatively, speaker 190 may be operably connected with controller 156. For instance, one or more additional connectors may be provided to connect speaker 190 with controller 156. Accordingly, signals (e.g., electronic signals) may be exchanged between controller 156 and speaker 160. In detail, standard (e.g., non-artificial intelligence related) signals or audio outputs may be provided to speaker 190 from controller 156 (e.g., without having to pass through voice module 170).

According to embodiments described herein, each of a voice module (e.g., a voice module PCB), a microphone assembly (e.g., a microphone PCB), and a speaker may be independently provided within an appliance. Advantageously, each element may be fully modular. In detail, specific positioning may be adjusted for each of the voice module, the microphone assembly, and the speaker. Additionally or alternatively, more or fewer elements (e.g., additional speakers, additional microphone assemblies, etc.) may be provided easily during assembly.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A domestic appliance defining a vertical direction, a lateral direction, and a transverse direction, the domestic appliance comprising:
a cabinet;
a user interface comprising an interface printed circuit board (PCB);
a voice module PCB operably connected with the interface PCB, the voice module PCB comprising one or more voice assistant modules;
a microphone PCB provided separate from the voice module PCB, the microphone PCB having a plurality of microphone receivers attached thereto, the microphone PCB being operably connected with the voice module PCB; and
a speaker operably connected with the voice module PCB.

2. The domestic appliance of claim 1, further comprising:
an interface housing attached to the cabinet, wherein the user interface, the voice module PCB, the microphone PCB, and the speaker are accommodated within the interface housing, and wherein the interface housing comprises a front face and a rear face.

3. The domestic appliance of claim 2, wherein the user interface further comprises a plurality of microphone holes corresponding to the plurality of microphone receivers, the plurality of microphone holes being positioned at a lateral side of the user interface and spaced apart along the vertical direction.

4. The domestic appliance of claim 3, wherein the plurality of microphone holes is defined in the front face of the interface housing.

5. The domestic appliance of claim 2, wherein the plurality of microphone receivers comprises two microphone receivers, the two microphone receivers spaced apart from each other along the vertical direction.

6. The domestic appliance of claim 2, wherein the microphone PCB is connected to the voice module PCB via a first board-to-board harness.

7. The domestic appliance of claim 6, wherein the speaker is connected to the voice module PCB via a second board-to-board harness.

8. The domestic appliance of claim 7, wherein the rear face of the interface housing comprises a speaker outlet facing rearward along the transverse direction, and wherein the speaker is provided proximate the speaker outlet.

9. The domestic appliance of claim 8, wherein the speaker is attached to an interior surface of the rear face of the interface housing.

10. The domestic appliance of claim 1, wherein the domestic appliance is a laundry treatment appliance comprising:
a wash tub provided within the cabinet; and
a wash basket rotatably provided within the wash basket.

11. A user interface assembly for an appliance, the user interface assembly comprising:
an interface printed circuit board (PCB);
a voice module PCB operably connected with the interface PCB, the voice module PCB comprising one or more voice assistant modules;
a microphone PCB provided separate from the voice module PCB, the microphone PCB having a plurality of microphone receivers attached thereto, the microphone PCB being operably connected with the voice module PCB; and
a speaker operably connected with the voice module PCB.

12. The user interface assembly of claim 11, further comprising:
an interface housing attached to the appliance, wherein the interface PCB, the voice module PCB, the microphone PCB, and the speaker are accommodated within the interface housing, and wherein the interface housing comprises a front face and a rear face.

13. The user interface assembly of claim 12, further comprising a plurality of microphone holes corresponding to the plurality of microphone receivers, the plurality of microphone holes being positioned at a lateral side of the interface housing and spaced apart along a vertical direction.

14. The user interface assembly of claim 13, wherein the plurality of microphone holes is defined in the front face of the interface housing.

15. The user interface assembly of claim 12, wherein the plurality of microphone receivers comprises two microphone receivers, the two microphone receivers spaced apart from each other along a vertical direction.

16. The user interface assembly of claim 12, wherein the microphone PCB is connected to the voice module PCB via a first board-to-board harness.

17. The user interface assembly of claim 16, wherein the speaker is connected to the voice module PCB via a second board-to-board harness.

18. The user interface assembly of claim 17, wherein the rear face of the interface housing comprises a speaker outlet facing rearward along a transverse direction, and wherein the speaker is provided proximate the speaker outlet.

19. The user interface assembly of claim 18, wherein the speaker is attached to an interior surface of the rear face of the interface housing.
